(19) United States
(12) Patent Application Publication
(10) Pub. No.: US 2014/0297925 A1
(43) Pub. Date: Oct. 2, 2014

(54) STORAGE DEVICE WITH SELF-CONTAINED INFORMATION STORAGE SPACE

(71) Applicant: SK hynix Inc., Icheon-si Gyeonggi-do (KR)

(72) Inventor: Chin Fan WEI, Zhubei City (TW)

(73) Assignee: SK hynix Inc., Icheon-si Gyeonggi-do (KR)

(21) Appl. No.: 14/145,615

(22) Filed: Dec. 31, 2013

(30) Foreign Application Priority Data
Mar. 29, 2013 (TW) 102205801

(51) Int. Cl. G06F 12/02

(52) U.S. Cl. CPC G06F 12/0246
USPC 711/103

(57) ABSTRACT

A storage device with self-contained information storage space includes at least a type-I non-volatile memory and a type-II non-volatile memory which form a data storage region and an information storage region, respectively. The type-II non-volatile memory has higher endurance than the type-I non-volatile memory. The type-I and type-II non-volatile memory are connected to a controller through a parallel interface and a series interface, respectively. The storage device uses the high-storage-density type-I non-volatile memory to meet high-capacity storage space requirement and uses the high-endurance type-II non-volatile memory to store important information and therefore ensure system stability, thereby solving problems facing existing storage devices—information stored in high-storage-density memory gets damaged easily because of an increase in programming/erase (P/E) cycles thereof.

### CROSS-REFERENCES TO RELATED APPLICATION

The present application claims priority under 35 U.S.C. §119(a) to Taiwan application number 102205801, filed on Mar. 29, 2013, in the Taiwanese Intellectual Property Office, which is incorporated herein by reference in its entirety.

### FIELD OF THE INVENTION

The present invention relates to storage devices, and more particularly, to a storage device with information storage space built from self-contained non-volatile memory.

### BACKGROUND OF THE INVENTION

NAND flash memory not only features high cell density and therefore high storage density, but also has high erasing speed; hence, NAND flash memory is suitable for use as high-capacity storage device. To further increase storage density and meet high-capacity storage space requirement, plenty of process technologies were developed successively, including SLC, MLC, and TLC. MLC and TLC enable each memory cell to store two or three pieces of data. Therefore, MLC and TLC have a much higher storage density than SLC which enables each memory cell to store only one piece of data. However, although MLC and TLC have a much higher storage density than SLC, MLC and TLC perform worse than SLC in endurance. SLC-based NAND flash memory has at least 10,000 programming/erase (P/E) cycles; however, MLC-based NAND flash memory has 3,000 P/E cycles only, and TLC-based NAND flash memory has 300 P/E cycles only. Moreover, if the P/E cycles of NAND flash memory increase, or when NAND flash memory is operating at very high or very low temperature, there will be an increase in error bits and therefore reduction of data retention duration. Furthermore, as indicated by research results, if the P/E cycle count increases to 3,000, the number of error bits will increase from 4 to 20 on average, and the data retention duration will decrease from five years to less than 12 months.

Furthermore, in addition to the aforesaid factors, data retention duration of NAND flash memory can shorten because of a decrease in nanoscale dimension, for example, the data retention duration of NAND flash memory fabricated by a 2X nanometer process equals approximately a half of the data retention duration of NAND flash memory fabricated by a 5X nanometer process.

As indicated above, although NAND flash memory is advantageously characterized by high storage density and therefore is applicable to high-capacity storage devices, its endurance depends on the process technology applied and dimensions, and in consequence the stability of the resultant storage devices poses a challenge. As shown in FIG. 2, which is a structural schematic view of a conventional storage device that essentially comprises a controller 80 connected to a communication interface port 81 and at least a NAND flash memory 82. The NAND flash memory 82 each allocates a major portion of its space to a data storage region 821 and a minor portion of its space to an information storage region 822 for storing important information, such as program code. Unlike the data storage region 821, the information storage region 822 stores invariable important information. As a result, if there is any error bit in the information storage region 822, important information stored therein will be damaged and therefore become inaccessible.

As mentioned before, to meet high-density high-capacity requirement, existing storage devices can use high-storage-density NAND flash memory. A low P/E cycle count is typical of this kind of NAND flash memory. Once the P/E cycles increase to a specific amount, the quantity of error bits will increase evidently and therefore affect the data retention duration, to the detriment of the completeness of information stored in the information storage region 822. In view of this, it is necessary to come up with a solution of processing important information in a manner to ensure the stability of the system of the storage device.

### SUMMARY OF THE INVENTION

It is an objective of the present invention to overcome the aforesaid drawbacks of the prior art.

In order to achieve the above and other objectives, the present invention provides a storage device with self-contained information storage space, comprising:

at least a type-I non-volatile memory having high storage density and forming a data storage region for storing data;

a type-II non-volatile memory forming an information storage region to store information except data, being formed from non-volatile memory except the type-I non-volatile memory, and having higher endurance than the type-I non-volatile memory;

a controller connected to the type-I non-volatile memory through a parallel interface and connected to the type-II non-volatile memory through a series interface; and

a communication interface port connected to the controller.

As indicated above, the storage device of the present invention uses the high-storage-density type-I non-volatile memory to meet high-capacity storage space requirement and uses the high-endurance (high P/E cycle count, considerable temperature endurance) type-II non-volatile memory to store important information. The type-I non-volatile memory forms a data storage region and therefore has a chance of repetitious programming/erase. To prevent an increase in the programming/erase (P/E) cycles of the type-I non-volatile memory to cause damage to important information stored therein, the present invention uses the high-endurance type-II non-volatile memory to form an information storage region for storing important information so that its characteristics, including dispensing the need to perform programming/erase frequently and manifesting high endurance, ensure that important information stored in the storage device will not get damaged because of an increase in P/E cycles, thereby ensuring system stability.

### BRIEF DESCRIPTION OF THE DRAWINGS

FIG. 1 is a circuit block diagram of a preferred embodiment of the present invention; and

FIG. 2 (PRIOR ART) is a circuit block diagram of a conventional storage device.

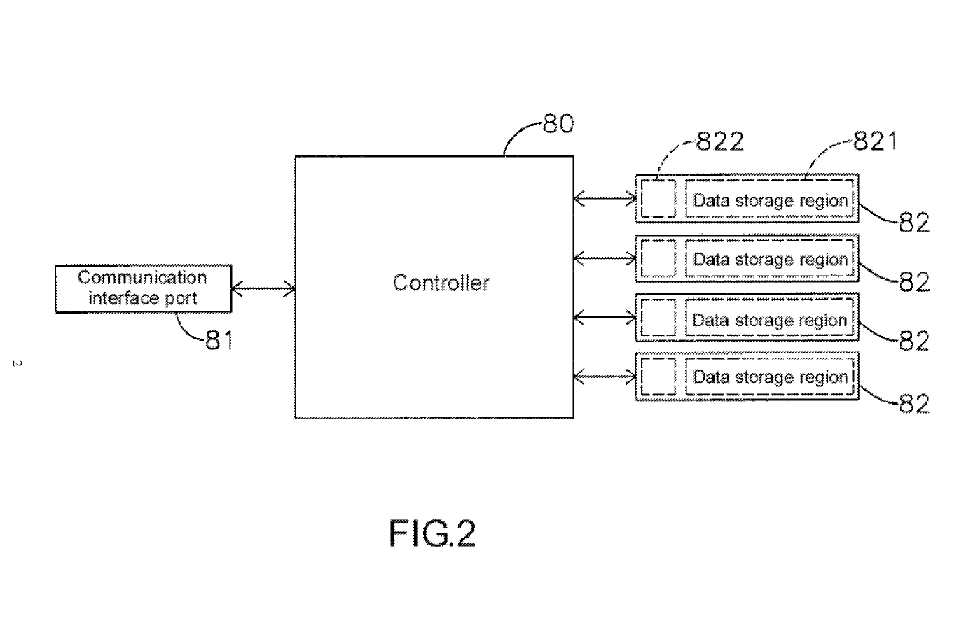

### DETAILED DESCRIPTION OF THE PREFERRED EMBODIMENTS

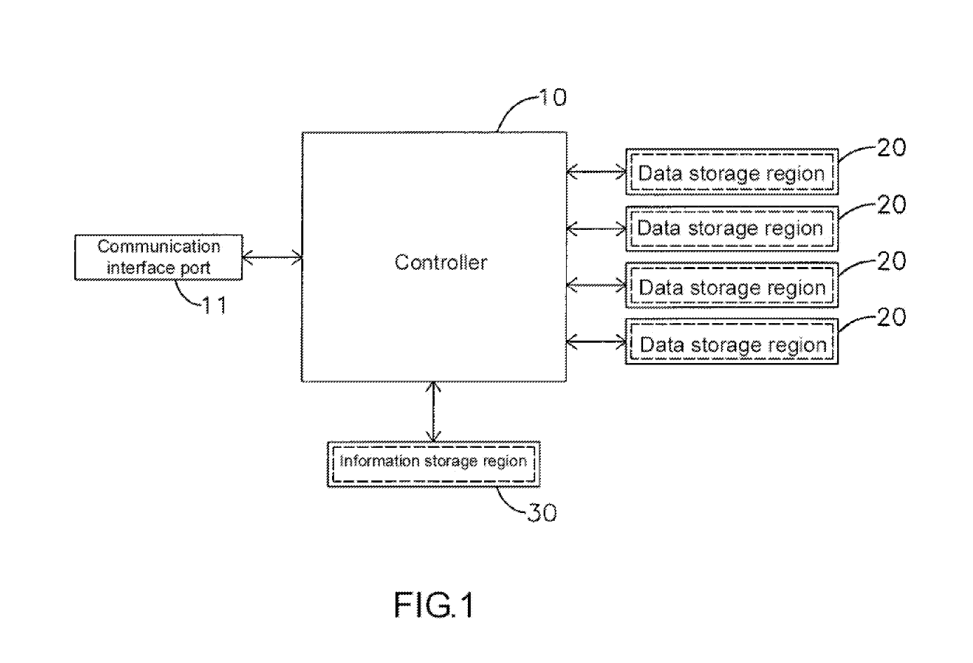

Referring to FIG. 1, in a preferred embodiment of the present invention, a storage device with self-contained information storage space comprises a controller 10, a communication interface port 11, at least a type-I non-volatile memory 20, and a type-II non-volatile memory 30. The communication interface port 11, the type-I non-volatile memory 20, and the type-II non-volatile memory 30 are each connected to the controller 10. The communication interface port 11 is eMMC, USB, or SATA.

In this embodiment, the type-I non-volatile memory 20 is NAND flash memory based on SLC, MLC, or TLC. The type-I non-volatile memory 20 has high storage density and forms a data storage region for storing a large amount of data. The type-I non-volatile memory 20 is connected to the controller 10 through a parallel interface and is accessible by the controller 10. The parallel interface is ONFi or Toggle.

The type-II non-volatile memory 30 is formed from non-volatile memory except type-I non-volatile memory. The type-II non-volatile memory 30 provides an information storage region independent of the data storage region to store important information, such as program code and applications. In this embodiment, the type-II non-volatile memory 30 is NOR flash memory with as many as 100,000 programming/erase (P/E) cycles. The type-II non-volatile memory 30 is connected to the controller 10 through a series interface. In this embodiment, the series interface is SPI.

As indicated above, the storage device of the present invention has a self-contained data storage region and a self-contained information storage region which are formed from type-I and type-II non-volatile memory 20, 30, respectively. In the preferred embodiment, the self-contained data storage region and the self-contained information storage region are formed from NAND flash memory and NOR flash memory, respectively. NAND flash memory is characterized by high storage density and high programming/erase (P/E) speed and therefore is suitable for use as storage media. NOR flash memory is read quickly, but is much slower than NAND flash memory in writing after erasing and, prior to erasing, writing 0 to storage bits in an erase block; hence, NOR flash memory is suitable for use in storing information which seldom or never changes, such as program code and applications. The present invention is characterized in that: the information storage region requires no frequent reciprocative programming/erase (P/E) and therefore the low programming/erase (P/E) speed is insignificant; and NOR flash memory has advantages, such as high endurance (high P/E cycle count, considerable temperature endurance) and therefore information stored therein will not get damaged even if P/E cycles or error bits increase. Due to the above characteristics, the storage device of the present invention is suitable for use in storing any system information needed to be protected, such as firmware code and system software.

As indicated above, the mainstream trend of storage devices is toward forming a data storage region from non-volatile memory which has high-storage-density and incurs low memory cell costs. However, the data storage region requires frequent reciprocative programming/erase (P/E) and therefore has a high chance of causing an increase in error bits as a result of an increase in the P/E cycle count and an abrupt change of temperature. Although it is possible to cope with the increase in error bits by software, it is not feasible to store invariable information in non-volatile memory with high storage density as existing storage devices do. According to the present invention, the information storage region is independent of the high-storage-density non-volatile memory and is formed from high-endurance non-volatile memory so that important information will not be damaged in case of an increase in error bits caused by an increase in the P/E cycle count of the high-storage-density non-volatile memory, and in consequence the stability of the system of the storage device is effectively ensured.

What is claimed is:

1. A storage device with self-contained information storage space, comprising:
at least a type-I non-volatile memory having high storage density and forming a data storage region for storing data;
a type-II non-volatile memory forming an information storage region to store information except data, being formed from non-volatile memory except the type-I non-volatile memory, and having higher endurance than the type-I non-volatile memory;
a controller connected to the type-I non-volatile memory through a parallel interface and connected to the type-II non-volatile memory through a series interface; and
a communication interface port connected to the controller.

2. The storage device with self-contained information storage space of claim 1, wherein the type-I non-volatile memory is NAND flash memory, and the type-II non-volatile memory is NOR flash memory.

3. The storage device with self-contained information storage space of claim 2, wherein the parallel interface is one of ONFi and Toggle.

4. The storage device with self-contained information storage space of claim 2, wherein the series interface is SPI.

5. The storage device with self-contained information storage space of any one of claim 1, wherein the endurance is indicative of a programming/erase (P/E) cycle count.

6. The storage device with self-contained information storage space of any one of claim 1, wherein the endurance is indicative of temperature endurance.

7. The storage device with self-contained information storage space of claim 5, the communication interface port is one of eMMC, USB, and SATA.

8. The storage device with self-contained information storage space of claim 6, wherein the communication interface port is one of eMMC, USB, and SATA.

9. The storage device with self-contained information storage space of claim 5, wherein the type-II non-volatile memory stores system information.

10. The storage device with self-contained information storage space of claim 6, wherein the type-II non-volatile memory stores system information.

11. The storage device with self-contained information storage space of any one of claim 2, wherein the endurance is indicative of a programming/erase (P/E) cycle count.

12. The storage device with self-contained information storage space of any one of claim 3, wherein the endurance is indicative of a programming/erase (P/E) cycle count.

13. The storage device with self-contained information storage space of any one of claim 4, wherein the endurance is indicative of a programming/erase (P/E) cycle count.

14. The storage device with self-contained information storage space of any one of claim 2, wherein the endurance is indicative of temperature endurance.

15. The storage device with self-contained information storage space of any one of claim 3, wherein the endurance is indicative of temperature endurance.

16. The storage device with self-contained information storage space of any one of claim 4, wherein the endurance is indicative of temperature endurance.
